(19) United States
(12) Patent Application Publication
(10) Pub. No.: US 2015/0252811 A1
(43) Pub. Date: Sep. 10, 2015

(54) Compressor Device

(71) Applicant: Chin-Hsiang Tang, Taoyuan City (TW)

(72) Inventor: Chin-Hsiang Tang, Taoyuan City (TW)

(21) Appl. No.: 14/505,527

(22) Filed: Oct. 3, 2014

(30) Foreign Application Priority Data
Mar. 7, 2014 (TW) 103203896

(51) Int. Cl. F04D 25/06; H02K 7/00; F04D 29/054; H02K 3/18; H02K 1/27; F25B 31/02; H02K 1/28

(52) U.S. Cl. CPC F04D 25/0606; F25B 31/02; H02K 7/003; H02K 1/28; H02K 3/18; H02K 1/27; F04D 29/054

(57) ABSTRACT

A compressor device includes a compressor (1) and a motor (2). The compressor (1) includes a body (11). A transmission shaft (12) is mounted to a side of the body (11). The motor (2) includes a base (21). A stator (22) is mounted in the base (21). A rotor (23) is mounted in the stator (22). The rotor (23) is connected to the transmission shaft (12) of the compressor (1). The motor (2) is directly coupled to the compressor (1) to reduce the number of components, reducing the costs and the installation space.

### BACKGROUND OF THE INVENTION

The present invention relates to a compressor device and, more particularly, to a compressor device including a compressor and a motor having a rotor coupled to a transmission shaft of the compressor to save the costs and to reduce the installation space.

Compressors have been widely used in vehicles, refrigerators, air conditioners, etc. However, compressors cannot operate by themselves and must be driven by a motor or an engine. FIG. 1 shows a conventional compressor 7 connected to and driven by a motor 8 by a belt 9 mounted around a pulley 71 coupled to the compressor 7 and a pulley 81 coupled to the motor 8. However, the overall costs are increased due to many components which also have a higher possibility of damage. Furthermore, the transmission between the compressor 7 and the motor 8 (or an engine) requires a larger space. Thus, a need exists for a novel compressor device that mitigates and/or obviates these disadvantages.

### BRIEF SUMMARY OF THE INVENTION

A compressor device according to the present invention includes a compressor and a motor. The compressor includes a body. A transmission shaft is mounted to a side of the body. The motor includes a base. A stator is mounted in the base. A rotor is mounted in the stator. The rotor is connected to the transmission shaft of the compressor.

The rotor of the motor can include first and second sides and an opening extending from the first side through the second side. A follower can be mounted to the first side of the rotor. The follower includes a spline hole. The transmission shaft of the compressor includes an outer periphery having a spline located outside of the side of the body. The outer periphery of the transmission shaft further includes a distal end having a threaded portion. The threaded portion extends through the opening of the rotor and the spline hole of the follower. The spline is coupled with the spline hole. A nut is engaged with the threaded portion.

The side of the compressor can further include a supporting portion through which the transmission shaft extends. A bearing is mounted around the supporting portion and is received in the opening of the rotor.

The first side of the rotor of the motor can include a plurality of positioning holes. The follower can include a plurality of positioning pegs extending from a side of the follower. The plurality of positioning pegs is fixed in the plurality of positioning holes.

The side of the body of the compressor can further include a plurality of first fixing holes. A connecting disc can be fixed to the side of the body. The connecting disc can include a plurality of first through-holes and a second fixing hole. A first fastener extends each of the plurality of first through-holes and is fixed in one of the plurality of first fixing holes of the body. The base of the motor can further include a plurality of limiting holes. A cover can be mounted to a side of the base. The cover includes a plurality of second through-holes. A second fastener extends through each of the plurality of second through-holes and one of the plurality of limiting holes of the base and is fixed in one of the plurality of the second fixing holes of the connecting disc.

The base of the motor can further include an outer periphery with a plurality of fins.

The motor can further include a plurality of coils annularly mounted in the stator. The rotor can further include a plurality of magnets annularly mounted on an outer periphery of the rotor.

The present invention will become clearer in light of the following detailed description of illustrative embodiments of this invention described in connection with the drawings.

### DESCRIPTION OF THE DRAWINGS

FIG. 1 is a schematic top view of a conventional compressor connected to a motor by a belt.

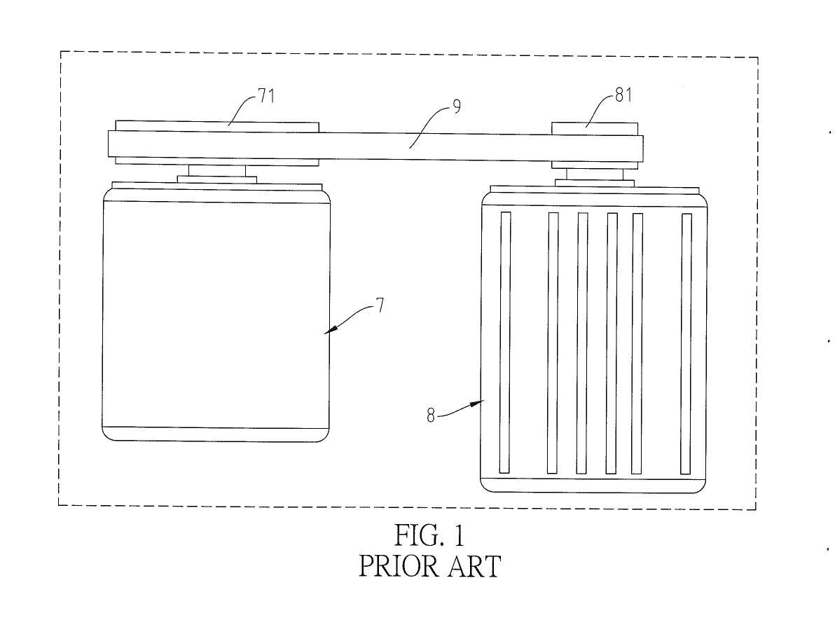

FIG. 2 is a perspective view of a compressor device according to the present invention.

FIG. 3 is a perspective view of the compressor device of FIG. 2 with a cover removed to show an interior of the compressor device.

FIG. 4 is a perspective view of a follower of the compressor device of FIG. 2.

FIG. 5 is an exploded, perspective view of the compressor device of FIG. 2.

FIG. 6 is a cross sectional view of the compressor device of FIG. 2.

### DETAILED DESCRIPTION OF THE INVENTION

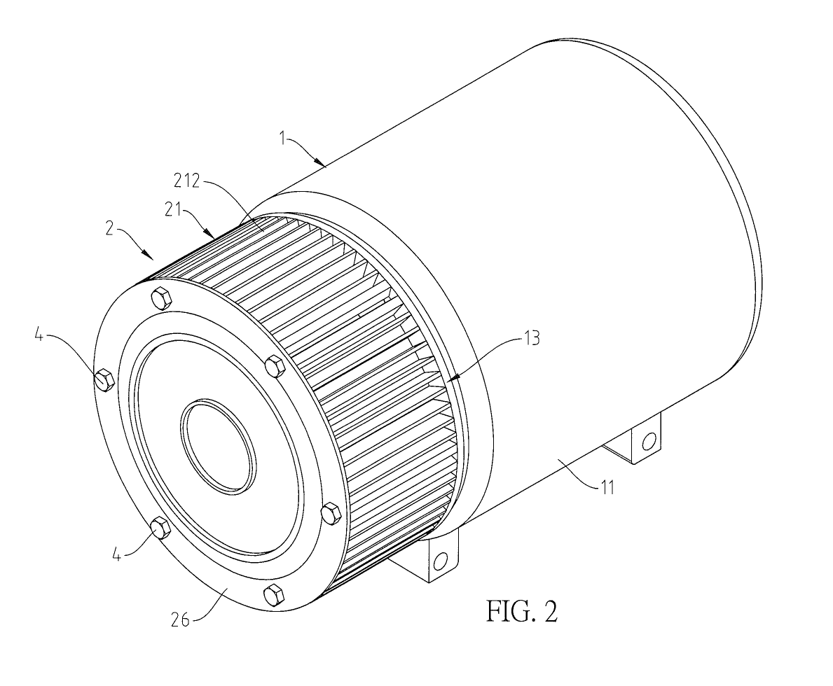

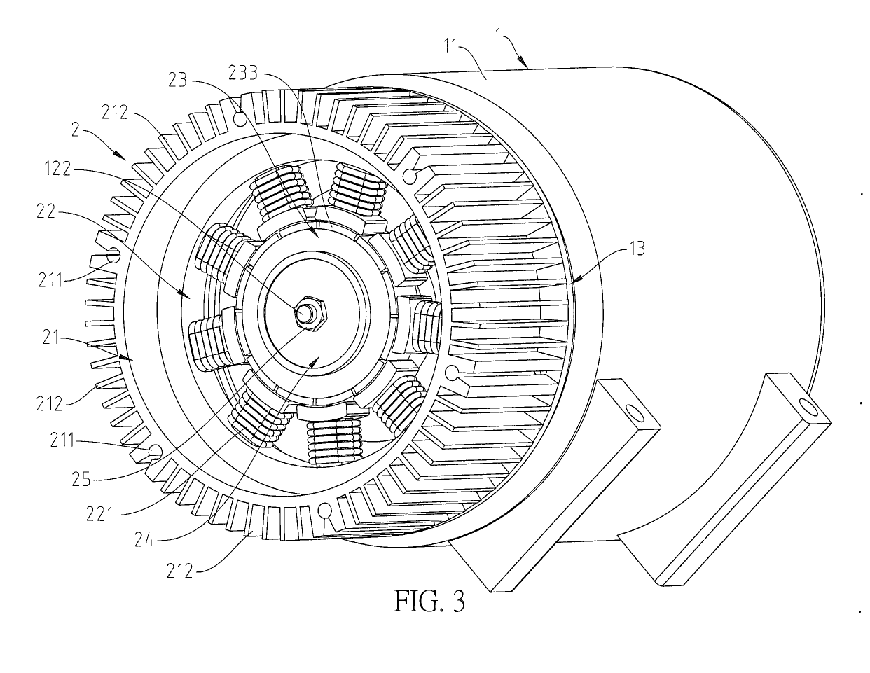

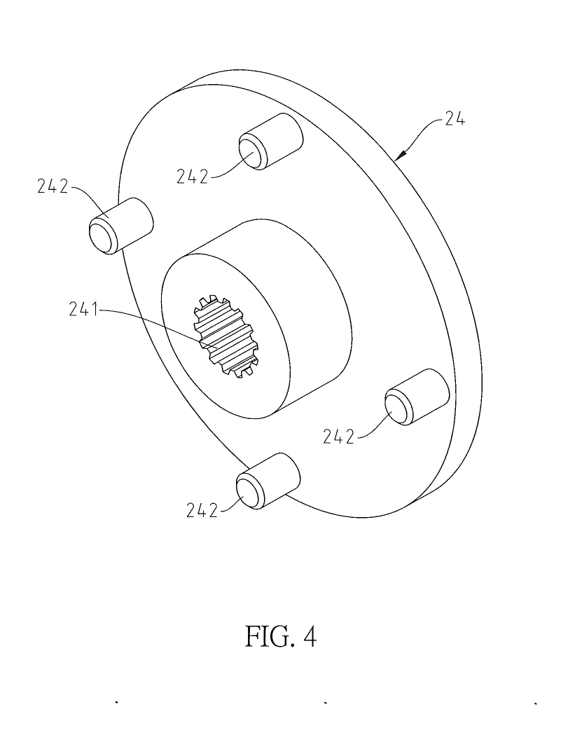

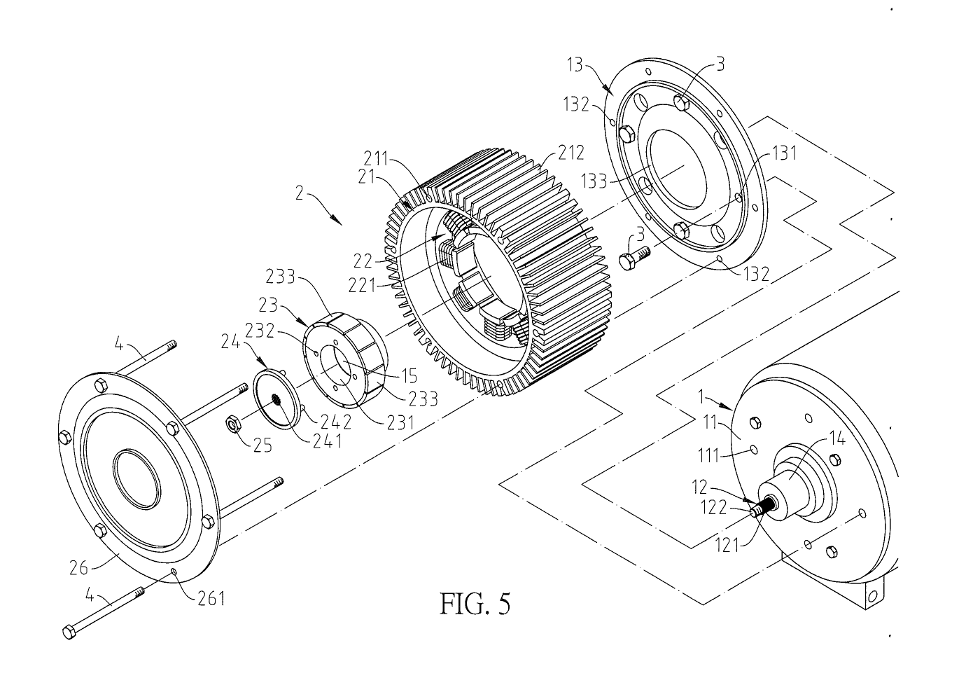

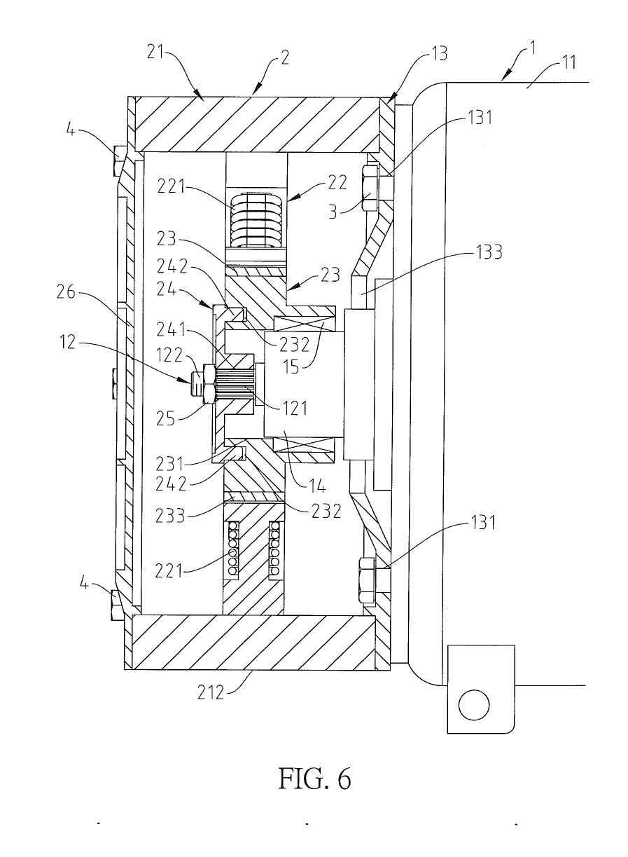

With reference to FIGS. 2-6, a compressor device according to the present invention includes a compressor 1 and a motor 2. The compressor 1 includes a body 11 and a connecting disc 13. A supporting portion 14 is formed on a side of the body 11. A transmission shaft 12 is mounted to the side of the body 11 and has an end extending through the supporting portion 14 to the outside. A bearing 15 is mounted around the supporting portion 14. The transmission shaft 12 includes an outer periphery having a spline 121 located outside of the side of the body 11. The outer periphery of the transmission shaft 12 further includes a distal end having a threaded portion 122. The side of the body 11 adjacent to the transmission shaft 12 has a plurality of first fixing holes 111.

The connecting disc 13 includes a cutout portion 133, a plurality of first through-holes 131 around the cutout portion 133, and a plurality of second fixing holes 132 around the first through-holes 131. A first fastener 3 extends each first through-hole 131 and is fixed in one of the first fixing holes 111 of the body 1. Thus, the connecting disc 13 is fixed to the body 11, and the end of the transmission shaft 12 is exposed via the cutout portion 133 of the connecting disc 13.

The motor 2 includes a base 21. A cover 26 is mounted to a side of the base 21 and includes a plurality of second through-holes 261. A second fastener 4 extends through each second through-hole 261. A stator 22 is mounted in the base 21. A rotor 23 is mounted in the stator 22. A plurality of limiting holes 211 extends from the side of the base 21 through the other side of the base 21. The base 21 of the motor 2 further includes an outer periphery with a plurality of fins 212. The motor 2 further includes a plurality of coils 221 annularly mounted in the stator 22.

The rotor 23 includes a plurality of magnets 233 annularly mounted on an outer periphery of the rotor 23. The rotor 23 of the motor 2 includes first and second sides and an opening 231 extending from the first side through the second side. A follower 24 is mounted to the first side of the rotor 23 and includes a spline hole 241. The first side of the rotor 23 of the motor 2 includes a plurality of positioning holes 232. A plurality of positioning pegs 242 extends from a side of the follower 24. The positioning pegs 242 are fixed in the positioning holes 232.

In assembly, the base 21 of the motor 2 is placed to the connecting disc 13 of the compressor 1. The threaded portion 122 of the transmission shaft 12 extends through the opening 231 of the rotor 23 and the spline hole 241 of the follower 24 to expose the threaded portion 122 of the transmission shaft 12. The spline 121 is coupled with the spline hole 241. A nut 25 is engaged with the threaded portion 122. Thus, the rotor 23 of the motor 2 is connected to the transmission shaft 12 of the compressor 1. The bearing 15 is received in the opening 231 of the rotor 23. Then, the cover 26 is mounted to the base 21. Each second fastener 4 extends through one of the limiting holes 211 of the base 21 and is fixed in one of the second fixing holes 132 of the connecting disc 132. Thus, the base 21 is fixed to the connecting disc 13, completing the assembly.

When the motor 2 operates, rotation of the rotor 23 drives the transmission shaft 12 of the compressor 1 to rotate, actuating the compressor 1 to operate. Since the rotor 23 of the motor 2 directly drives the compressor 1, the overall volume and the costs of the compressor device are greatly reduced. Furthermore, since the compressor 1 and the motor 2 are coupled to each other by the spline 122 and the spline hole 241, the possibility of damage can effectively be reduced to prolong the service life of the compressor device.

Although specific embodiments have been illustrated and described, numerous modifications and variations are still possible without departing from the scope of the invention. The scope of the invention is limited by the accompanying claims.

1. A compressor device comprising:
a compressor including a body, with a transmission shaft mounted to a side of the body; and
a motor including a base, with a stator mounted in the base, with a rotor mounted in the stator, and with the rotor connected to the transmission shaft of the compressor.

2. The compressor device as claimed in claim 1, with the rotor of the motor including first and second sides and an opening extending from the first side through the second side, with a follower mounted to the first side of the rotor, with the follower including a spline hole, with the transmission shaft of the compressor including an outer periphery having a spline located outside of the side of the body, with the outer periphery of the transmission shaft further including a distal end having a threaded portion, with the threaded portion extending through the opening of the rotor and the spline hole of the follower, with the spline coupled with the spline hole, and with a nut engaged with the threaded portion.

3. The compressor device as claimed in claim 2, with the side of the compressor further including a supporting portion, with the transmission shaft extending through the supporting portion, with a bearing mounted around the supporting portion, and with the bearing received in the opening of the rotor.

4. The compressor device as claimed in claim 2, with the first side of the rotor of the motor including a plurality of positioning holes, and with the follower including a plurality of positioning pegs extending from a side of the follower, and with the plurality of positioning pegs fixed in the plurality of positioning holes.

5. The compressor device as claimed in claim 1, with the side of the body of the compressor further including a plurality of first fixing holes, with a connecting disc fixed to the side of the body, with the connecting disc including a plurality of first through-holes and a second fixing hole, with a first fastener extending each of the plurality of first through-holes and fixed in one of the plurality of first fixing holes of the body, with the base of the motor including a plurality of limiting holes, with a cover mounted to a side of the base, with the cover including a plurality of second through-holes, and with a second fastener extending through each of the plurality of second through-holes and one of the plurality of limiting holes of the base and fixed in one of the plurality of the second fixing holes of the connecting disc.

6. The compressor device as claimed in claim 1, with the base of the motor further including an outer periphery with a plurality of fins.

7. The compressor device as claimed in claim 1, with the motor further including a plurality of coils annularly mounted in the stator, and with the rotor further including a plurality of magnets annularly mounted on an outer periphery of the rotor.
